(19) United States
(12) Patent Application Publication
(10) Pub. No.: US 2008/0294542 A1
(43) Pub. Date: Nov. 27, 2008

(54) System and Method For Web-Based Customizable OTC Options Trading

(76) Inventor: Niall O'Brien, New York, NY (US)

Correspondence Address: PAUL, HASTINGS, JANOFSKY & WALKER LLP, 875 15th Street, NW, Washington, DC, 20005, US

(21) Appl. No.: 11/751,246

(22) Filed: May 21, 2007

(51) Int. Cl. G06Q 40/00; G06F 17/40

(52) U.S. Cl. 705/37

(57) ABSTRACT

A method for processing electronic requests for price quotes is provided. In the method, a request for a price quote is received, wherein the request comprises one or more characteristics of an over the counter option inputted into an interactive electronic display. A price quote is determined for the option based on the request and is displayed on the interactive electronic display. The ability to execute an electronic sale of the option having the one or more characteristics at the quoted price is provided at the interactive electronic display. A termsheet is automatically populated upon the execution of the sale and is accessible by the parties to the sale.

### BACKGROUND

1. Field of the Invention

The present invention relates generally to online derivatives trading and, more particularly, to web-based systems and methods for improved trading of over-the-counter options.

2. Background of the Invention

FIG. 1 shows a conventional process 10 by which requests for price quotes for over-the-counter (OTC) options instruments are handled. In the process 10, clients 12 typically converse with a sales representatives 14 by means of instant messaging (e.g., AOL Messenger) and phone conversations 20, Clients 12 of financial institutions submit and negotiate terms of requests for price quotes with sales representatives 14 of the financial institutions through these means. The information is then typically relayed 22 by phone or messaging (chat) to a relevant trader 16, who assesses the details of the request to obtain a price. The price information is relayed 22 back to the sales representative 14, who then communicates 20 the information to the client 12. The client 12 then chooses to trade according to the provided terms or may reject the quote.

In some instances, clients 12 make requests for quotes across various classes of instruments or that are otherwise in different markets, thereby necessitating that the sales representative 14 communicate with several different traders 16 to obtain price quotes. In such cases, the sales representative 14 then has to collate the details of the quotes from the various traders 16 as appropriate and relay 20 them back to the client 12 over an instant messaging interface or telephone. Clearly, the relaying and collation of such detailed information back and forth between several people raises a significant risk that an error may be made in process and is a very cumbersome system.

If a client 12 accepts any of the quotes, the details are sent to sales 14, who then contacts trading 16 again to confirm the details and price. Trading 16 may then perform any hedging, if appropriate, and the details of the resolved price are sent back to sales 14. Once all of the terms have been confirmed, a trade ticket 24 with all of the details of the trade is typed out and sent to trade support/operations personnel 18, who then manually book the trades into a real-time risk system, which is fed downstream into settlements/confirmations systems. Sales representatives 14 additionally fill out a termsheet manually, typically in a spreadsheet format, to send to the client 12.

Further adding to the cumbersome nature of the existing procedure for OTC options trading, clients 12 request many more quotes than they intend to trade. This results in a large amount of wasted time and effort on the part of the sales representative 14 and traders 16 in communicating back and forth regarding every request.

OTC options trading has unique characteristics that make fully automated systems such as those used for general exchange trading inapposite. OTC options trading by its nature requires increased interaction and communication between the trading parties since there is no predetermined market-defined price for the instruments. Each OTC option is customized based on negotiated terms such as strike price and expiration. Traders may receive a basket of requests for quotes from clients, requiring substantial time and effort to obtain prices for each of the requests.

Accordingly, there exists a need for a system to process OTC options requests for quotes more efficiently and practically, and that overcomes the deficiencies of conventional systems.

### BRIEF SUMMARY OF THE INVENTION

In accordance with an embodiment of the present invention, a method for processing electronic requests for price quotes is provided. In the method, a request for a price quote is received, wherein the request comprises one or more characteristics of an over the counter option inputted into an interactive electronic display. A price quote is determined for the option based on the request and is displayed on the interactive electronic display. The ability to execute an electronic sale of the option having the one or more characteristics at the quoted price is provided at the interactive electronic display. A termsheet is automatically populated upon the execution of the sale and is accessible by the parties to the sale.

### BRIEF DESCRIPTION OF THE DRAWINGS

FIG. 1 is a schematic diagram of a conventional process of trading over-the-counter options.

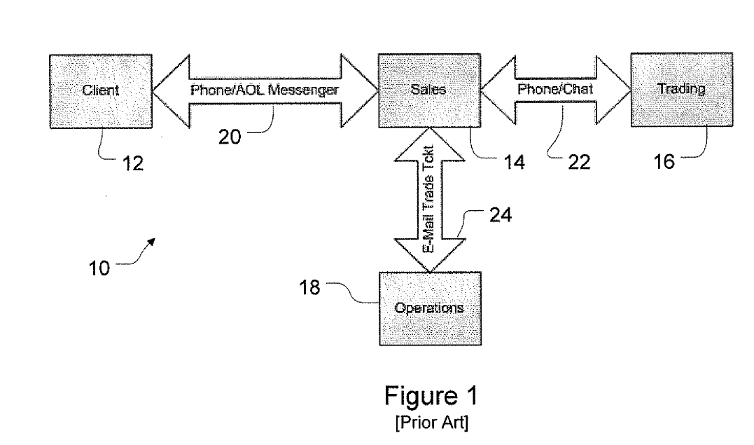

FIG. 2 is a flowchart of an over-the-counter options trading process in accordance with an embodiment of the present invention.

FIG. 3 is a state model diagram of an over-the-counter options trading process in accordance with an embodiment of the present invention.

FIG. 4 is an exemplary screenshot of a request for quote entry computer user interface in accordance with an embodiment of the present invention.

FIG. 5 is an exemplary screenshot of a request for quote status computer user interface in accordance with an embodiment of the present invention.

FIG. 6 is an exemplary screenshot of a trading computer user interface in accordance with an embodiment of the present invention.

FIG. 7 is an exemplary trade history file in accordance with an embodiment of the present invention.

### DETAILED DESCRIPTION OF THE INVENTION

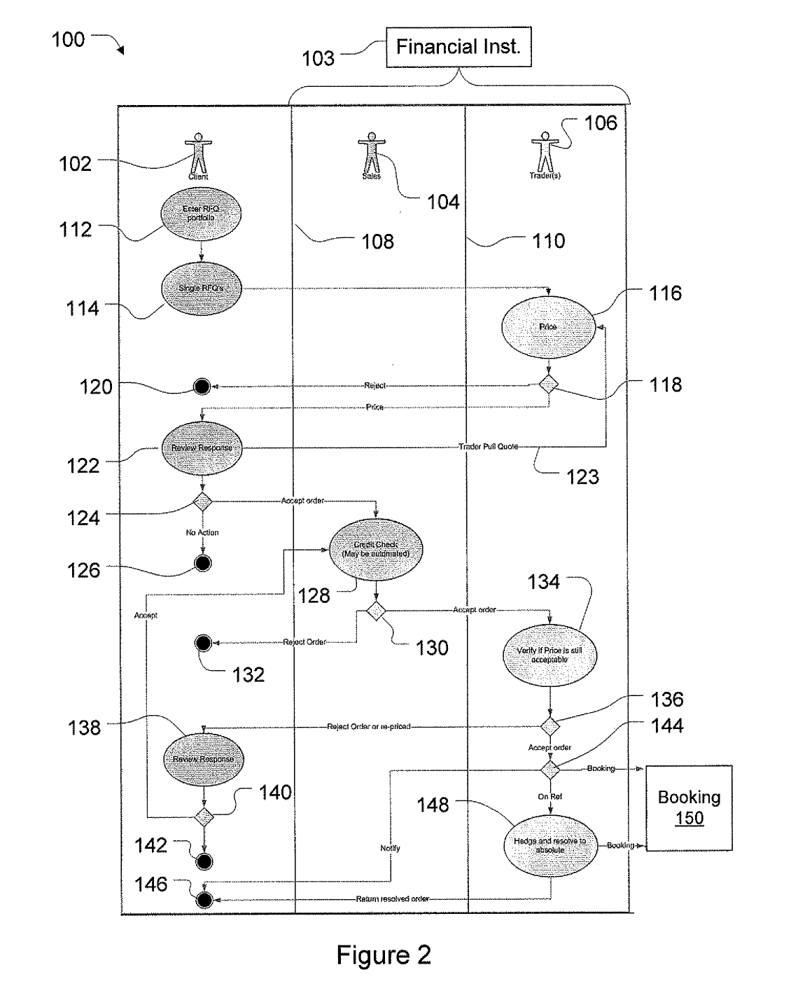

A web-based over-the-counter options trading system and method in accordance with the present invention is shown in FIG. 2. As shown, the system 100 may generally include three participating entities or actors: a client 102, a sales representative 104 for a financial institution 103, and a trader 106 for the financial institution 103. The trader 106 may be an employee of the financial institution 103 or the trader 106 may be an agent of the financial institution 103 acting on its behalf The boundary lines 108 and 110 divide the actors into their respective zones of action. Each of the items illustrated as within the zone of a particular actor are items that are engageable or actionable by the respective actor via a web- or network-based computer interface. The transferring of information across zone boundaries 108, 110 represents the transmission of the relevant information over the internet, local network, or other electronic means. It will be appreciated that both sales 104 and traders 106 may have access to view the information contained in any of the transmissions at any time. Accordingly, where it is indicated that a transmission is made from the client 102 to trading 106 across the zone of sales 104, sales 104 may be notified of such transmission or may otherwise have the capability to review the transmitted information.

Transmission means from the client 102 to sales 104 (crossing the line 108 in FIG. 2) may be different from or the same as transmission means from sales 104 to the trader 106. For example, the client 102 may access an external website provided by a financial institution 103 to input various information. The information may be transmitted over the internet by any traditional means. On the other hand, the sales representative 104 and the trader 106 may both have access to an internal network maintained by the financial institution 103 and therefore the transmissions between them may be through such an internal network or by email. Alternatively, sales 104 and trading 106 may also communicate over the internet, or the client 102 may communicate with sales 104 or 106 via email or any other electronic means.

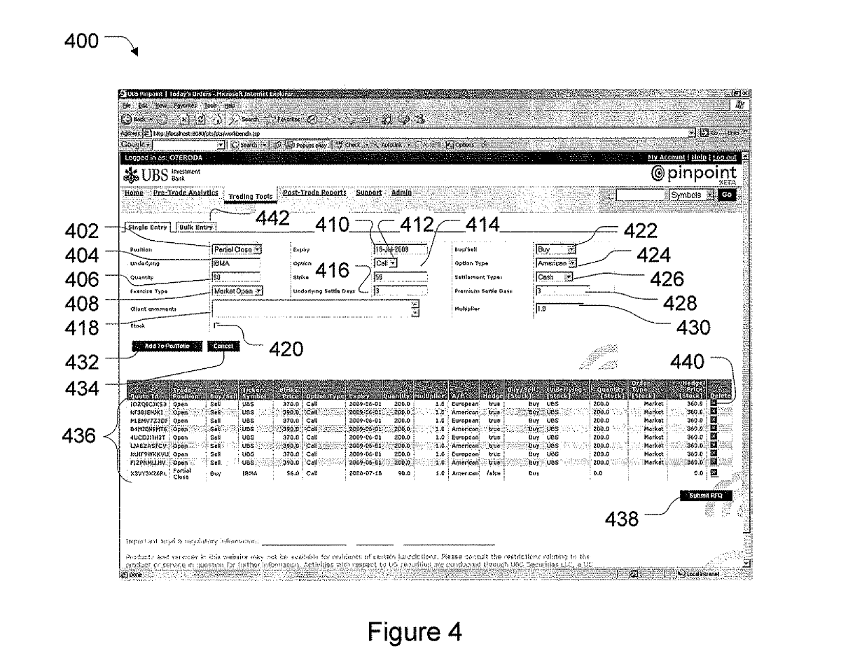

In the process for options trading 100 in accordance with the present invention, the client 102 accesses a website provided by the financial institution 103 and enters one or more requests for quotes (RFQ) in an RFQ entry computer user interface provided on the website, such as an RFQ interface as shown in FIG. 4. The one or more RFQs are considered an RFQ portfolio 112. The RFQ portfolio 112 may comprise a single RFQ 114 or it may include several RFQs for any number of options.

An RFQ interface 400, as shown in FIG. 4, may include various fields for entry of data such as trade position 402, underlying security 404, quantity 406, exercise type 408, expiry 410, call or put 412, strike price 414, underlying settle days 416, a comment field 418, stock indication 420, buy or sell 422, option type 424, settlement type 426, premium settle days 428, and/or multiplier 430. Any relevant fields may be provided for entry of information necessary or advantageous for the trading of options and is not limited to fields mentioned in the present description. The comments field 418 allows the client 102 to add any further information regarding the terms of the RFQ that do not have specific fields in the interface 400.

After the client 102 enters the desired information into the fields, the “Add to Portfolio” button may be clicked. An RFQ having the specified terms may then be displayed in a portfolio listing 436 located, for example, beneath the data entry area on the RFQ interface 400, as shown in FIG. 4. The interface 400 may be provided with an automated verification system to ensure that the client 102 has entered all of the information deemed required in order to generate a price quote in response to the RFQ. The “Cancel” button may be pressed to clear all data fields and, optionally, to return to a previous webpage.

The client 102 may also be able to indicate trade allocations to sub-accounts in the RFQ entry interface 400. Fields may be provided in the interface 400 specifically for entry of such information, or the client 102 may enter the allocation information (e.g., account numbers or other identifying characteristics) in the comments field 418, as shown in FIG. 4. The system in accordance with the present invention may be designed to process such information such that any trades denoted as being allocated to a sub-account will be executed for that sub-account.

Once each of the RFQs have been entered, they will be displayed in the RFQ listing 436, which represents the RFQ portfolio 112, and may include the terms of each of the RFQs organized in columns, as shown. This listing 436 enables the client 102 to review each of the RFQs to ensure that the correct terms are specified. If the client wishes to remove one or more of the RFQs, a delete button 440 arranged in the vicinity of the unwanted RFQ may be clicked to remove it. Once the client 102 is satisfied with the RFQ listing 436, the “Submit RFQ” button 438 may be clicked and the information will be transmitted to sales 104 and/or trading 106.

Bulk entry of RFQs may be enabled by clicking on the bulk entry tab link 442 on the interface 400. The link 442 will load a webpage that allows a user to upload a pre-existing file containing RFQ terms or to copy and paste a string of RFQs with their terms.

Once the RFQ portfolio listing 436 has been submitted, the RFQ portfolio 112 is broken into single RFQs 114 and each RFQ is electronically transmitted directly to a relevant trader 106 (with sales 104 having observer capabilities), containing the information submitted by the client 102. Each trader 106 who receives an RFQ 114 analyzes the request and, if feasible, responds with a price quote 116. The decision point 118 represents the trader's 106 decision as to whether a quote will be given in response to the request (RFQ). In the event that the request is not economically feasible or if the trader 106 otherwise decides not to give a quote, the RFQ is rejected and the client 102 is alerted 120 of the rejection. In other embodiments, the rejection alert 120 may be held in the system until each RFQ 114 in the RFQ portfolio 112 has been acted upon by the trader 106. If an RFQ 114 is rejected, the client 102 may then return to the RFQ entry step 112 to modify the request or enter a new request. If the trader 106 decides at decision point 118 that a quote may be given, the quote is transmitted to the client 102 for review 122.

In cases in which an RFQ portfolio 112 comprises more than one RFQ 114, each RFQ 114 may be sent to a different trader 106 for a quote (although in some cases, one trader 106 may receive all of the RFQs 114 in such a portfolio 112). In an embodiment of the invention, the client 102 will not receive any responses from the traders 106 until each RFQ 114 has been acted upon by the traders 106, whether by providing a quote or by rejecting the request. In another embodiment of the invention, each of the traders' 106 responses is transmitted to the client 102 as they are made without regard to the status of other requests in the RFQ portfolio 112.

Once all or some of the responses have been transmitted to the client 102 from the traders 106, the client may review the responses 122 and take separate action on each. Decision point 124 represents the client's 102 determination as to whether to pursue an option trade having the terms specified in one of the RFQs entered by the client 102 in step 112 at the price quoted by the trader 106 in step 116. The client 102 may make a separate determination with respect to each of the submitted RFQs that have been provided with a quote by the trader 106.

If the client 102 does not wish to accept the quote, no further action need be taken 126 by the client 102, and the quote can be set to expire at the end of the trading day or at any other fixed interval as desired. In another embodiment, the quote may have no time of expiration. As mentioned above, if an RFQ has been rejected 120, that particular RFQ is null, and the client may return to the RFQ entry step 112 if they wish to pursue the option by modification of the terms. At any time prior to acceptance of the quote by the client 102, the trader may pull the quote 123.

If the client 102 accepts the quote at 124, the status of the request becomes an “order” and the system may perform a credit check 128 to verify the ability of the client 102 to engage in the transaction. The credit check 128 may be performed by sales 104 or it may be an automated process built into the system 100. In such automated processes, it is appreciated that the salesperson 104 in FIG. 2 has no active function and may solely be an observer to the process. In other embodiments, it is possible to remove the salesperson 104 from the process completely such that the only actors are the client 102 and the relevant traders 106. If it is determined at decision point 130 that the client 102 has failed the credit check 128, the order is rejected 132 and an alert is provided to the client 102. If it is determined at point 130 that the client 102 has passed the credit check 128, the order may then be transmitted once again to the trader 106 to ensure that the quoted price is still acceptable 134.

At decision point 136, the trader 106 has the opportunity to review the order once again to determine whether the terms are still acceptable. If the terms are no longer acceptable, the trader 106 may revise the quote or reject the order. The modified response is then presented to the client 102 for review 138. At decision point 140, the client 102 may then accept the revised quote, in which case a credit check 138 is again carried out. The client 102 may decide that the terms of the quote are not acceptable and take no action, in which case the revised quote is left to expire 142. In some embodiments, this second credit check may be omitted in cases where the first credit check revealed sufficient credit or if the terms of the revised quote are such that the passing of the first credit check with respect to the original quote is sufficient to establish credit for the revised quote.

The cycle of the steps of credit check 128, sales or automated decision 130, trader verification of terms 134, trader decision 136, review 138, and client decision 140 may continue until the trader 106 decides in step 136 that a price accepted by the client 102 is acceptable. In such a case, the order advances to step 144. The cycle may also end if the trader 106 rejects the order in step 136, the client 102 does not accept the quote in step 140, or if the client 102 fails the credit check in step 130. In this manner, the present invention provides efficient automated repetitive credit checks that have been unavailable in prior art systems.

In step 144, after the trader 106 has decided that the accepted terms are acceptable, it is determined whether the quote had a reference stock trade. If there was no reference stock trade, the order advances directly to booking 150 and notification is provided 146 to the client 102. A client may, for example, wish to trade OTC options “delta neutral.” The term “delta” refers to the change in the options price relative to a change in the price of the underlying asset; it may be desirable in certain circumstances to assemble various trades such that the sum of all of the deltas is zero or close to zero. In the embodiment of the present invention, the client 102 may indicate the desired delta or reference asset and the trader 106 works out the necessary trades to achieve the client's intentions.

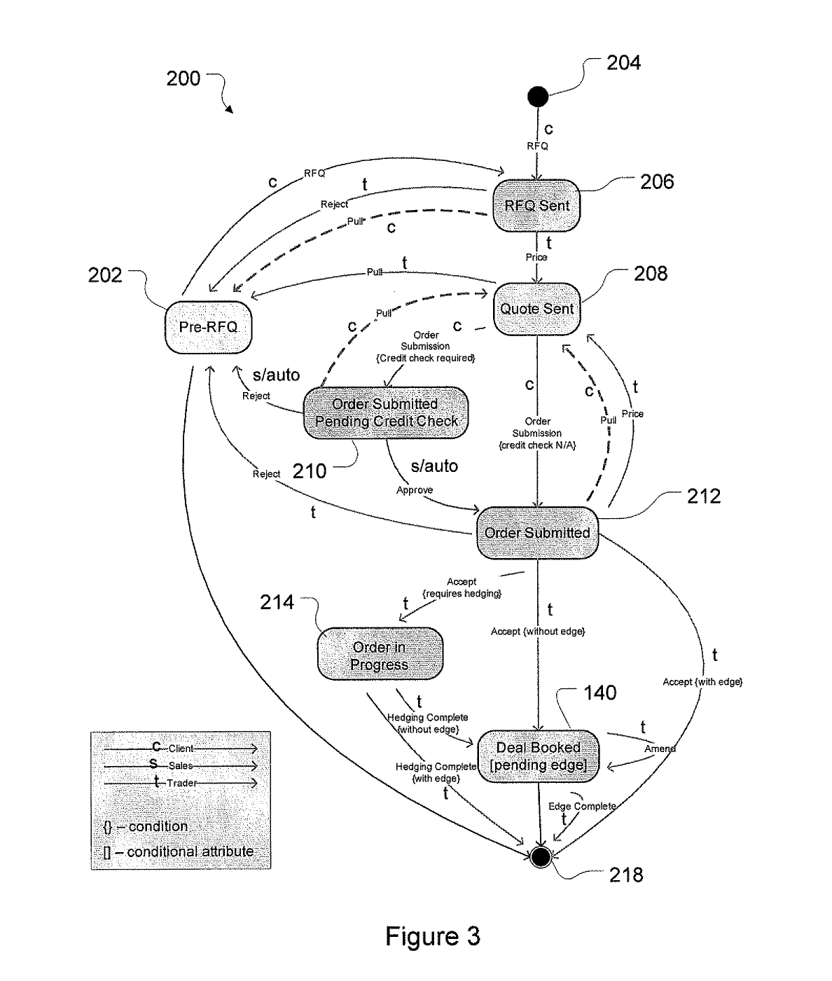

FIG. 3 shows a state model of a system 200 in accordance with the present invention. Various states are shown, along with the actions performed to move from one state to another. A state is defined with respect to a particular client of the financial institution and may, in other embodiments, be defined with respect to particular RFQs where multiple RFQ portfolios are permitted to be submitted simultaneously. The arrows extending from one state to another represent actions by the respective actors including the client 102, the sales representative 104, and the trader 106. Actions labeled with a “c” in FIG. 3 are typically performed by the client 102; actions labeled with a “t” in FIG. 3 are typically performed by the trader 106, and actions labeled with an “s” in FIG. 3 are typically performed by the sales representative 104.

State “Pre-RFQ” 202 may represent the state prior to any entry of RFQs or after an RFQ has been rejected or pulled. State 202 may represent the point at which a client navigates to a website and begins to enter an RFQ. Accordingly, the system is in state 202 with respect to a particular RFQ portfolio whenever the client is in a position to submit an RFQ or modify a rejected or pulled RFQ. State 204 is also shown to represent any source of an RFQ.

From state 202 or 204, the client 102 may enter an RFQ or RFQ portfolio. Once the RFQ is sent by the client through, for example, the internet, the state changes to “RFQ Sent” 206. At state 206, the RFQ has been transmitted to the trader 106, who may then decide to quote a price or reject the RFQ. If the trader 106 rejects the RFQ, the system returns to state 202 and the client has the opportunity to modify or submit a new RFQ. If the trader 106 gives a price quote on the RFQ, the quote is sent to the client 102 and the system moves to state “Quote Sent” 208. In an embodiment, the client 102 may have the ability to pull the RFQ in state 206. In such an event, the trader 106 will not provide a price quote, the system will return to state 202, and the client 102 has the opportunity to modify or submit a new RFQ. The client 102 may be informed of any activity on the part of the trader 106, such as the fact that the trader 106 has begun to analyze the RFQ, by electronic messaging so as to increase client awareness of the progress of the RFQ.

Once the quote has been sent to the client 102 in state 208, the client 102 has the option to pursue the quote or take no action (which, as described above, may result in the expiration of the quote). If the client 102 accepts the quote, the system 200 may perform a credit check 210 if necessary or proceed directly to the “Order Submitted” state 212. The trader 106 further has the opportunity at state 208 to pull the quote if it is determined at some point that the quote is not feasible or is otherwise unacceptable. If the trader 106 pulls the quote in state 208, the system 200 moves to state 202 to give the client 102 an opportunity to modify or submit a new RFQ.

In the “Order Submitted” state 212, the trader 106 has a further opportunity to review the trade to determine whether the terms are acceptable. The client 102 may have the ability to amend the order. Preferably, since the order has not been filled, the abilities of the client 102 to amend the order are limited to execution instructions (i.e., quantity and comments). The client 102 may also have the ability to cancel the order at this state. If the terms are not acceptable to the trader 106, the trader 106 may reject the order and return the system 200 to state 202 for a new or modified RFQ. If they are acceptable, the trader 106 may accept the order, perform the edge (i.e., the option premium taken by the trader for taking on the risk of the trade), and execute the trade 218. If the trader 106 accepts the order but the edge has not been performed, the order is booked and the system 200 proceeds to the state “order in Progress” 216. Once the edge is performed, the trade is executed 218.

If the trader 106 accepts the order but a hedge is required or the order is otherwise not yet executed, the system 200 moves to state 214 where the hedge may be dealt. In the state 214, the client 102 may be prevented from making any further changes to the order, even as to quantity. If the client 102 wishes to change the quantity, they may provide a note in a “comments” section of the internet website and the trader can make the change. In the event that market prices move in the midst of executing an order in state 214, the untraded quantities of the order will have to be executed against the new price, which may be subject to approval by the client 102. The new prices may be communicated to the client through the comments section and fed to the client automatically.

The order may then be executed 218 if the edge has been performed or be booked at state 216 pending the edge, as similarly discussed above. Once the edge is performed, the trade may be executed 218.

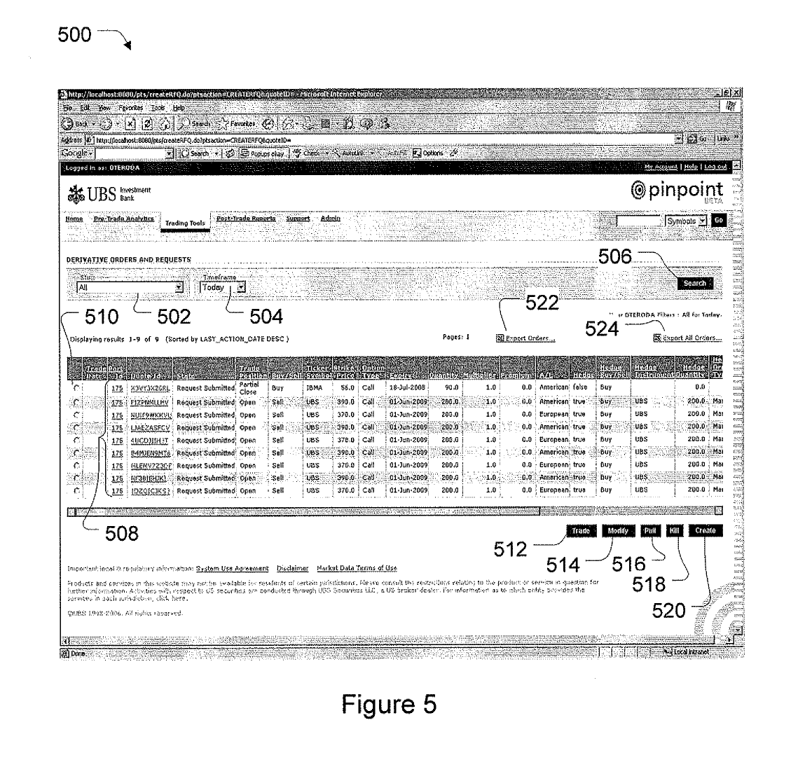

FIG. 5 is an example of an RFQ status computer user interface 500. Clients 102 can navigate to the status interface 500 from the same website that hosts the RFQ entry interface 400. In the status interface 500, a client 102 can view all of the RFQs that have been submitted to the financial institution 103 and their statuses. In the state field 502, a client 102 or other user may input the state of RFQs that are desired to be viewed. For example, a user may wish to view all RFQs that have been submitted that have not been acted upon by a trader 106. In this case, the user would select or input “request submitted” in the field 502 and click on the search button 506. The interface 500 would then return a listing 508 of all RFQs having a state of “request submitted.”

The user may further specify a timeframe in the timeframe field 504 in order to result in a list 508 of RFQs that have the inputted status within the inputted timeframe. In the example shown in FIG. 5, the user has selected “all” states in field 502 within the timeframe of “today” in field 504. The interface 500 has displayed all of the RFQs that are pending as of the current date. The displayed RFQs may be exported in a data file, for example a spreadsheet file, by selecting desired RFQs with radio buttons 510 and clicking the “Export Orders” link 522. A client 102 can choose to export all of the listed RFQs by clicking the “Export All Orders” link 524.

The client 102 may take actions with respect to each of the displayed RFQs by selecting the appropriate radio button 510 and clicking an action button, such as trade 512, modify 514, pull 516, kill 518, or create 520. Further actions may be added as deemed appropriate.

In some embodiments, the client 102 may have the option to display only pending or active RFQs, only rejected or expired RFQs, or all RFQs. In this manner, a negotiating history is captured for advantageous use by the client 102 as well as the financial institution 103 by having all RFQs made available, whether accepted or rejected, and filterable by the result. Provisions may additionally be made for the storage of any information communicated between the client 102 and the financial institution 103 by means of the comments field in the interface 400 or for any other communications recorded electronically. All of the RFQs made may be stored in a data storage facility maintained by the financial institution 103 for retrieval upon request through the status interface 500 or other means. The financial institution 103 may allow unlimited display to clients of RFQs made, or it may limit the availability of RFQs based on timeframes, results, particular characteristics, or other aspects. The limitations on the availability of RFQs to clients 102 may be imposed by appropriate software programming means.

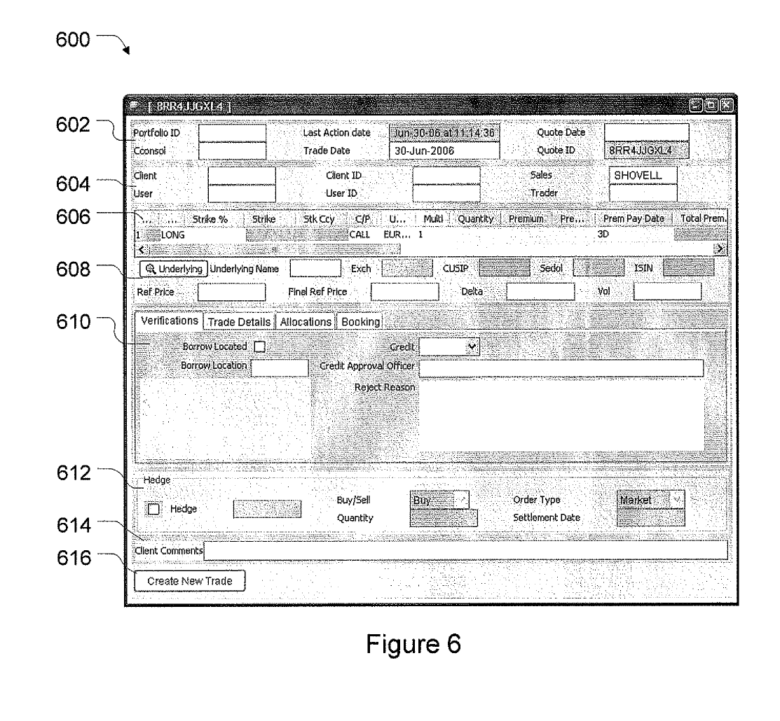

FIG. 6 shows an exemplary trading computer user interface 600. The trading interface 600 is configured for use by the traders 106 and may also be used or at least viewable by sales representatives 104. The trading interface 600 may be a web-based application or it may be produced by a program internal to the financial institution 103 and not accessible to external users. The trading interface 600 allows traders 106 to view the RFQs submitted by clients and to take various actions in response to or concerning the RFQs. The trading interface 600 may include any and/or all information associated with the client 102 and the client's respective RFQs or other investment information. The trading interface 600 shown in FIG. 6 is only exemplary of the type of information that may be displayed and processed and should not be construed as limiting or otherwise restrictive.

The trading interface 600 may include a portfolio information frame 602, which comprises identifying and historical information related to the particular portfolio for which an RFQ or a plurality of RFQs are made. The interface 600 may further include an actor identifying frame 604, which may include identifying information relating to the particular actors involved in the RFQ process, such as the client 102, the sales representative 104, and the trader 106. An RFQ listing 606 may be displayed on the interface 600, along with the terms organized, for example, in columns. A full list of all RFQs associated with a particular client and/or a particular account or portfolio may be provided. Alternatively, only those RFQs that require action by the trader 106 may be displayed. In one embodiment, a trader 106 or sales representative 104 may toggle or select between a display of all RFQs and a limited view of RFQs, which may be filtered according to a chosen RFQ status. An RFQ detail frame 608 may be provided for displaying further particulars of a selected RFQ. Frame 610 may be provided for inputting and processing more detailed information such as notes and other data related to verifications, trade details, allocations, and booking, as shown. A hedging frame 612 may be provided for displaying and processing hedge orders associated with one or more RFQs. A client comments frame 614 may be displayed to convey any information entered by the client 102 in the comments field 418 of the RFQ entry interface 400. A “Create New Trade” button 616 may be provided to enable the trader 106 or salesperson 104 to enter a new trade.

In accordance with a further aspect of the present invention, a financial institution 103 maintains various records, data processing, and bookkeeping information for access by internal entities (e.g., salespeople 104 and traders 106) as well as clients 102. Such information may be available for viewing or download by clients 102 via the web-based computer user interface. In other embodiments, the information may be automatically transmitted (e.g., by email or other electronic data transmission) to the client's backend order management systems. Since essentially all activity is carried out in electronic form, records of the activity in various retrievable forms are instantly available. The information may be recorded in suitable database files, such as spreadsheets or any other format chosen by the client 102 that is compatible with its backend systems. Clients may be able to specify their preferred file formats that will integrate well with their own systems. Clients may also choose whether they will receive the files by, for example, downloading over a secure internet connection or by email. Clients may also specify the frequency of file transmission (e.g., intra-daily, daily, weekly, monthly, etc.).

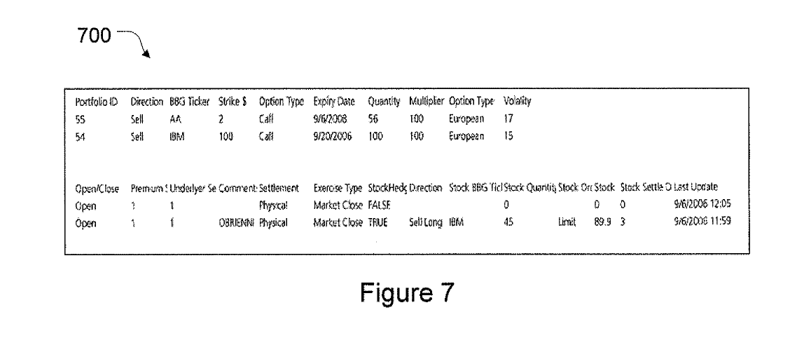

One of these informational products may be a trade history file 700, an example of which is shown in FIG. 7. The trade history file 700 may be automatically processed and fed to a backend order management system of a client 102. Where appropriate, the trade file 700 may be accessible and optionally downloadable by a client 102 via the internet or may be automatically sent to the client 102 via email or other messaging services. The trade file 700 may include the details of any executed trades and be updated continuously or in periodic intervals (e.g., every 30 minutes). The trade files 700 may be archived by a host server provided by the financial institution 103 and may be accessible by the client 102 for online reference. The trade files 700 may alternatively be transmitted to the client 102 periodically by, for example, email or other messaging services. The trade files 700 may be provided with header information, such as portfolio, account, and client information, in order to facilitate data processing by users.

The system may also systematically generate a daily or real-time valuation file that contains a client's current valuation of their open OTC trades. The valuation file may be accessible over the internet similarly to the trade file discussed above, or may be periodically transmitted to the client or automatically to the client's ledger system by, for example, email each business day, week, and/or month. The valuation files may be provided with header information in order to facilitate automatic data processing by the client or the client's ledger system.

A termsheet may be automatically generated by the system in accordance with the present invention upon booking the trade. The termsheet may include all relevant trade information and may include, for example, call or put information, strike price, expiration, and trade identification number. The termsheet may be generated in electronic form (e.g., portable document format (PDF)) or on paper, and be transmitted to the client 102, sales 104, and/or trading 106. If the order is amended after the deal is booked, a revised termsheet may be generated and distributed as appropriate. Any other electronic file format may be used as desired by any of the users and as appropriate. In another embodiment, a uniform resource locator (URL) may be sent to the parties, which provides a link to the termsheet hosted on a server. The termsheet may then be downloaded. In providing an automatically generated termsheet, the present invention affords significant benefits over prior art systems, which relied on manual entries on all sides of the transaction (e.g., as between the client and the financial institution).

In addition, as described herein, the tangible output of the system and method of the present invention includes the creation of termsheets, the creation of daily sales logs, and the execution of trades. The use of the termsheets, the use of the daily sales logs or trade history files fed to the clients' backend systems, and the use of these tangible results are important aspects of the present invention. Thus, the system and method (as implemented through technology) described herein produce these and other tangible results.

In one embodiment of the present invention, system 100 is a web-based tool capable of operating standalone in a trusted environment and can be launched within any designated user working environment. The system has automated links to a core banking platform to authenticate users, to obtain client assets and liability data intraday.

In accordance with an embodiment of the present invention, instructions adapted to be executed by a processor to perform a method are stored on a computer-readable medium. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

In the context of this document, a “computer-readable medium” can be any means that can contain, store: communicate, propagate, or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for processing electronic requests for price quotes for over the counter sales of options, the requests submitted by a client of a financial institution to the financial institution, the method comprising:
providing an interactive electronic display for access by the client;
receiving a request for a price quote, the request being submitted by the client via the interactive electronic display and being received by the financial institution, the request comprising terms of an over the counter option including underlying security, strike price, and expiry;
determining a price quote for the option based on the terms of the request, the determination being made by the financial institution or an agent thereof;
displaying the price quote on the interactive electronic display;
providing to the client the ability to accept the price quote at the interactive electronic display;
if the client accepts the price quote, transmitting the client's acceptance to the financial institution;
after receiving the client's acceptance, determining whether the price quote is still valid for an option having the terms submitted in the request;
if the price quote is still valid, executing the sale;
automatically populating a termsheet upon the execution of the sale; and
transmitting the termsheet to the client.

2. The method of claim 1, wherein a log of all sales made in a day is fed to a backend system of the client.

3. The method of claim 1, wherein the terms further comprise one or more of the group consisting of: trade position, quantity, exercise type, buy or sell, and option type.

4. The method of claim 1, wherein, in the event that a price quote is not accepted by the client, canceling the request after a predetermined time such that it may not be accepted from the interactive electronic display.

5. The method of claim 4, wherein the terms of canceled requests are accessible for viewing by the client at any time on the interactive electronic display.

6. The method of claim 4, wherein the terms of canceled requests are accessible for viewing by the client for a limited time on the interactive electronic display.

7. The method of claim 1, further comprising:
providing the ability for the client to retract the request at the interactive electronic display.

8. The method of claim 1, further comprising checking the credit of the client after acceptance, wherein the request is rejected if the client is not found creditworthy.

9. The method of claim 8, wherein the step of determining whether the price quote is still valid is performed after checking the credit of the client.

10. The method of claim 1, wherein if the price quote is not valid, modifying the price quote and transmitting the modified price quote to the client.

11. The method of claim 10, wherein the electronic sale is contingent on the client passing a credit check, and wherein the credit check is processed each time the price quote is modified by the financial institution and accepted by the client.

12. The method of claim 1, further comprising:
providing to the client the ability to amend a request after the price quote has been accepted by the client and transmitted to the financial institution.

13. The method of claim 12, wherein the ability to amend a request is limited to changes in quantity.

14. The method of claim 1, further comprising:
providing to the client the ability to cancel a request after the price quote has been accepted by the client and transmitted to the financial institution.

15. The method of claim 1, further comprising:
canceling a request after the price quote has been accepted by the client and transmitted to the financial institution, wherein the financial institution performs the cancellation.

16. The method of claim 1, further comprising:
pulling a price quote after it has been transmitted to the client, wherein the financial institution performs the pulling of the price quote.

17. The method of claim 1 further comprising:
transmitting a valuation file to the client, the valuation file indicating the value of options held by the client.

18. A method for processing electronic requests for price quotes for over the counter sales of options, the requests submitted by a client of a financial institution to the financial institution, the method comprising:
providing an interactive electronic display for access by the client;
receiving a request for a price quote, the request being submitted by the client via the interactive electronic display and being received by the financial institution, the request comprising terms of an over the counter option including underlying security, strike price, and expiry;
determining a price quote for the option based on the terms of the request, the determination being made by the financial institution or an agent thereof;
displaying the price quote on the interactive electronic display;
providing to the client the ability to accept the price quote at the interactive electronic display;
if the client accepts the price quote, transmitting the client's acceptance to the financial institution;
checking the credit of the client;
determining whether the price quote is still valid for an option having the terms submitted in the request;
if the price quote is still valid, executing the sale;
if the price is not valid, modifying the price quote and transmitting the modified price quote to the client;
accepting, by the client, the modified price quote;
checking the credit of the client a second time;
determining whether the modified price quote is still valid for an option having the terms submitted in the request; and
if the modified price quote is still valid, executing the sale of the option.

19. The method of claim 18, further comprising automatically populating, using a computer, a termsheet with terms based on the terms submitted in the request and the modified price quote accepted by the client, and transmitting the populated termsheet to the client.

20. A system for processing electronic requests for price quotes for over the counter sales of options, the requests submitted by a client of a financial institution to the financial institution, the system comprising:
an interactive electronic display for access by the client;
a request for a price quote submitted by the client via the interactive electronic display and being received by the financial institution, the request comprising terms of an over the counter option including underlying security, strike price, and expiry;
a price quote, determined by the financial institution or an agent thereof, for the option based on the terms of the request;
an acceptance of the price quote, wherein the acceptance is made by the client at the interactive electronic display and is transmitted to the financial institution; and
a termsheet that is automatically populated upon the execution of the sale and transmitted to the client.
